(19) United States
(12) Patent Application Publication
(10) Pub. No.: US 2024/0409344 A1
(43) Pub. Date: Dec. 12, 2024

(54) TRACTION LADDER FOR LOADING TRACKED VEHICLE

(71) Applicant: Caliber, Inc., Burnsville, MN (US)

(72) Inventors: Ernest J DELANGHE, Burnsville, MN (US); Kasey PIPO, Burnsville, MN (US); William BUTTERFIELD, Burnsville, MN (US); Jon LEIKVOLD, Burnsville, MN (US); Anthony DELANGHE, Burnsville, MN (US); Steven POTTER, Burnsville, MN (US)

(21) Appl. No.: 18/581,031

(22) Filed: Feb. 19, 2024

Related U.S. Application Data
(60) Provisional application No. 63/485,843, filed on Feb. 17, 2023.

(51) Int. Cl. B65G 69/30

(52) U.S. Cl. CPC B65G 69/30

(57) ABSTRACT

A traction ladder is configured to engage a ramp engaging a platform of a transportation vehicle or accessory where the traction ladder includes a first side rail having a first proximal end configured to engage the ground and a first distal end configured to engage a crossbar of the ramp, and a second side rail having a second proximal end configured to engage the ground and a second distal end configured to engage a crossbar of the ramp. The traction ladder includes a plurality of crossbars spaced from each other, each cross bar is pivotally attached to the first side rail at a first pivot and pivotally attached to the second side rail at a second pivot. The traction ladder is configured to be positioned in a first position by pivoting the first and second sider rails about the first and second pivots such that the plurality of traction ladder crossbars are substantially orthogonal to the first and second side rails. The traction ladder is configured to be moved to a second position by pivoting the first and second side rails about the first and second pivots such that the first and second side rails are positioned proximate each other.

### BACKGROUND

The present disclosure relates to a traction ladder configured to assist a track powered vehicle to transition from ground level onto a ramp. More particularly, the present disclosure relates to a traction ladder configured to engage a ramp and transition the track of a snow machine from ground level onto the ramp.

Many people ride track powered vehicles for transportation and enjoyment on snow-covered ground. The track powered vehicle, such as a snowmobile, has skis in the front of the vehicle which allow a rider to steer the vehicle, while the skis aid in keeping the tracked vehicle on the snow surface. The track is located behind the skis and is powered by an engine, where the track rotates to propel the snow machine.

Areas and trails designated for snowmobiles are typically a distance from the snow machine owner's location. As such, snowmobiles are typically transported on a bed of a trailer or truck to a site where the rider can begin riding the snowmobile.

To transfer a snow machine or other tracked vehicle to a platform of a transportation vehicle or accessory, a ramp is typically positioned proximate an edge of the platform where a ground engaging edge of the ramp is substantially even with the ground. The ramp provides a sloped transition from the ground to the platform where the skis first engage the ramp followed by the track.

When loading the snow machine back onto the platform of the transportation vehicle or accessory and depending upon the pitch of the ramp, the front end of the track can raise off of the ground as the skis travel up the ramp. As the track is displaced from the ground, the number of lugs that engage the ground or snow is reduced. If a sufficient number of lugs are elevated from the ground or snow, the track can lose traction and spin out, which will prevent the snow machine from traveling up the ramp and onto the platform of the transportation vehicle or accessory.

As such, there is a need for equipment that aids in transitioning a track of a vehicle from ground level and onto the ramp while providing traction to the track in front of the ramp as the skis begin to travel up the ramp.

### SUMMARY

An aspect of the present disclosure relates to a traction ladder that is configured to engage a ramp engaging a platform of a transportation vehicle or accessory. The traction ladder includes a first side rail having a first proximal end configured to engage the ground and a first distal end configured to engage a crossbar of the ramp, and a second side rail having a second proximal end configured to engage the ground and a second distal end configured to engage a crossbar of the ramp. The traction ladder includes a plurality of crossbars spaced from each other, each cross bar being pivotally attached to the first side rail at a first pivot and pivotally attached to the second side rail at a second pivot. The traction ladder is configured to be positioned in a first position by pivoting the first and second sider rails about the first and second pivots such that the plurality of crossbars of the traction ladder is substantially orthogonal to the first and second side rails. The traction ladder is configured to be moved to a second position by pivoting the first and second side rails about the first and second pivots such that the first and second side rails are positioned proximate each other.

Another aspect of the present disclosure relates to a method for loading a snow machine having spaced apart skis and a track from ground level onto a platform of a transportation vehicle or accessory. The method includes positioning a ramp from ground level to the platform of a transportation vehicle or accessory at an angle θ₁. The method further includes providing a traction ladder having a first side rail having a first proximal end configured to engage the ground and a first distal end configured to engage a crossbar of the ramp, a second side rail having a second proximal end configured to engage the ground and a second distal end configured to engage a crossbar of the ramp, and a plurality of crossbars spaced from each other. Each cross bar of the traction ladder is pivotally attached to the first side rail at a first pivot and pivotally attached to the second side rail at a second pivot. The method includes moving the first and second side rails to a first position by pivoting the first and second sider rails about the first and second pivots such that the plurality of crossbars are substantially orthogonal to the first and second side rails, and attaching the first and second distal ends to the crossbar of the ramp such that the traction ladder is at an angle θ₂, where θ₂ is less than θ₁. The method includes moving the snow machine such that the skis of the snow machine engage the ramp at the angle θ₁ while the track engages the traction ladder at angle θ₂ such that the track more readily transitions to the ramp at angle θ₁ as the skis move up the ramp.

### BRIEF DESCRIPTION OF THE DRAWINGS

FIG. 1 is a perspective view of a ramp with a traction ladder

FIG. 2 is a perspective view of the traction ladder.

FIG. 3 is top view of the traction ladder.

FIG. 4 is a first sectional view of a pivotal connection of a side rail and cross bar of the traction ladder taken along section 4-4 in FIG. 3.

FIG. 5 is a second sectional view of the pivotal connection of the side rail and the cross bar of the traction ladder taken along section 5-5 in FIG. 3.

FIG. 6 is an illustration of the traction ladder in the first and second positions.

FIG. 7 is a side view of the ramp with the traction ladder.

### DETAILED DESCRIPTION

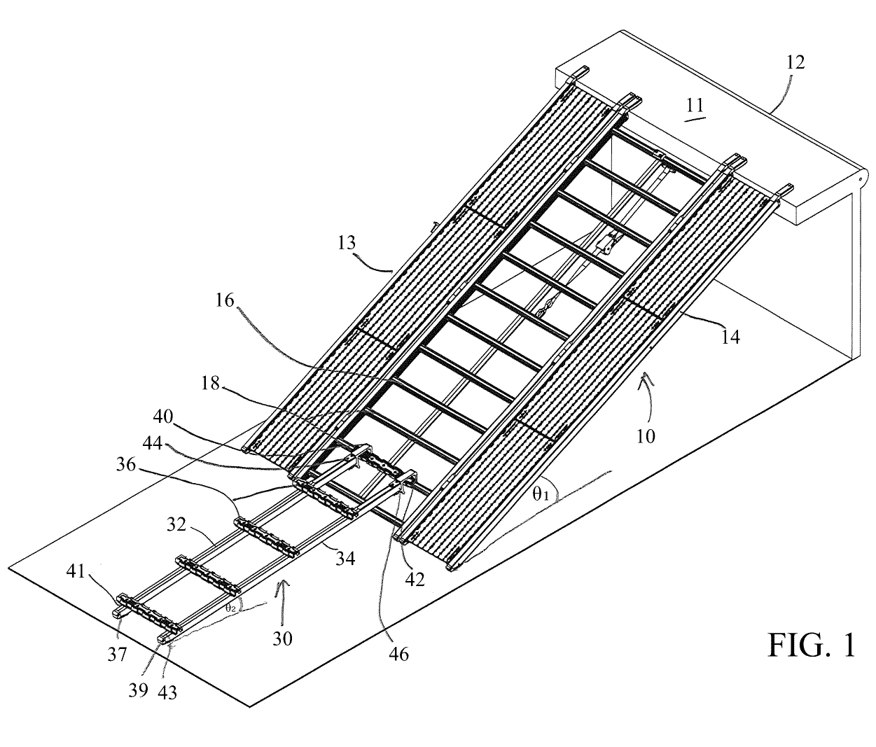

A traction ladder 30 for transitioning a track of a snow machine from ground level to a ramp is illustrated in FIG. 1. The traction ladder 30 is secured to a ramp 10, with the ramp 10 is engaging a surface 11 of a platform 12 of a transportation vehicle or accessory is illustrated in FIG. 1.

The ramp 10 includes left and right outer portions 13 and 14 that are configured to engage wheels of an all-terrain vehicle (ATV) or a utility task vehicle (UTV) and/or skis of a snowmobile. The ramp 10 includes a middle portion 16 secured to the left and right portions 12 and 14, where the middle portion 16 includes a plurality of spaced apart cross bars 18. The plurality of spaced apart cross bars 18 provide surfaces that the lugs of a track of a snow machine engage which propels the snow machine from ground level 20 to the surface 11 of the platform 12 of a transportation vehicle or accessory.

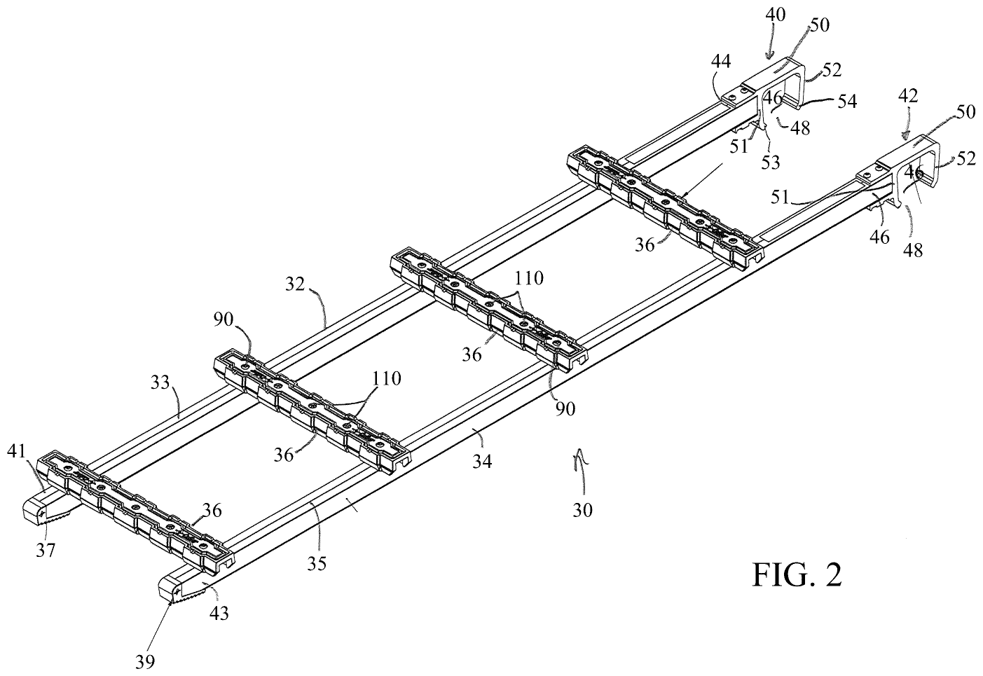

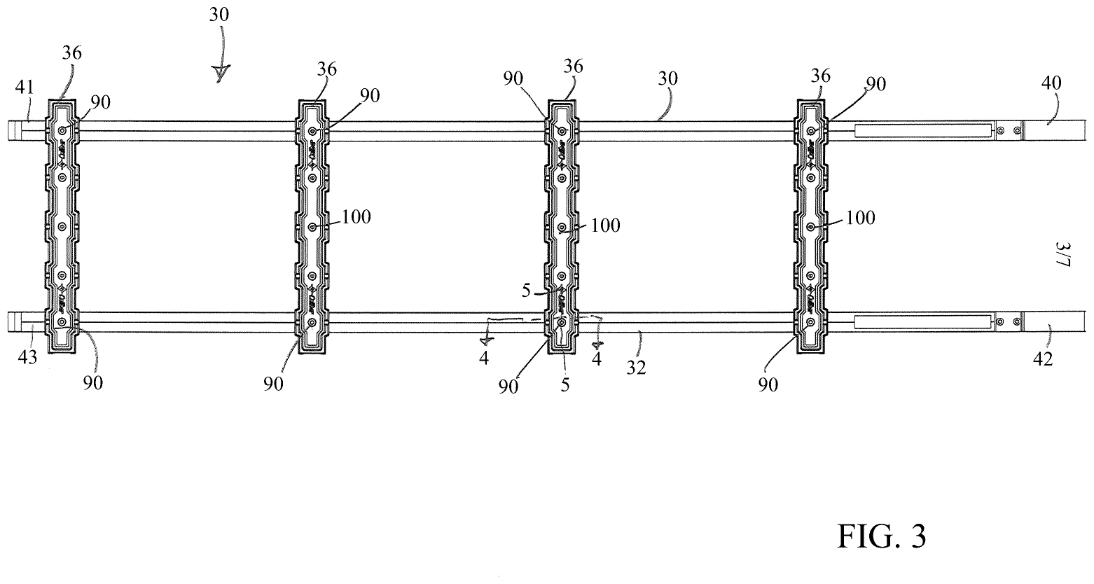

Referring to FIGS. 1-3, the traction ladder 30 includes left and right side rails 32 and 34, respectively, that are connected with a plurality of spaced apart cross bars 36. The left and right side rails 32 and 34. The left and right side rails 32 and 34 and have sufficient rigidity and strength to substantially prevent bowing as the snow machine moves along the traction ladder 30.

Mounting hooks 40 and 42 are attached to distal ends 44 and 46 of the left and right side walls 32 and 34, all respectively. The mounting hooks 40 and 42 are similarly constructed and common features will be given the same reference characters.

The mounting hooks 40 and 42 have cavities 46 with constricted entrances 48, where the constricted entrances 48 are sized to allow a cross bar 18 of the ramp 10 to pass into the cavities 46. The depth of the cavities 46 are longer than the height of the crossbars 18, such that when the mounting hooks 40 and 42 are positioned over the cross bar 18, a bottom surface of the cross bar 18 is above the constricted entrances 48. Prongs 51 and 52 extend from top portions 50 and define the cavities 46 and the constricted entrances 48. The prongs 51 and 52 have inwardly facing fingers 53 and 54 that aid in preventing the mounting hooks 20 and 42 from accidently or inadvertently detaching from the cross bar 18.

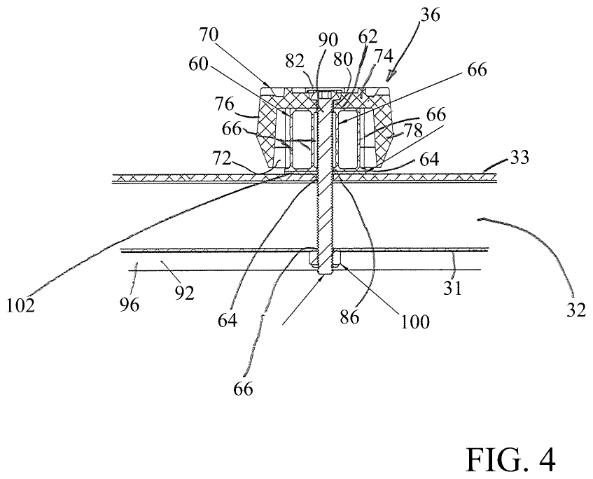

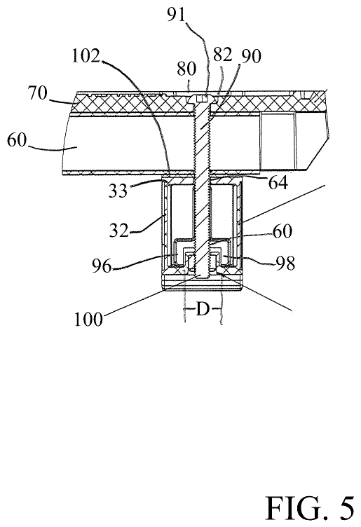

Referring to FIGS. 4 and 5, the cross bars 18 include a rung 60 that includes an upper wall 62 and a lower wall 64 that are joined with a plurality of spaced apart support ribs 66. A grip 70 is positioned about the rung 60 such that the rung 60 is positioned within a cavity 72 defined by a top wall 74 and spaced apart side walls 76 and 78 extending a length of the grip 70. The grip 70 protects the rung 60 from the lugs of the track of the snow machine and is sufficient hard and tough to resist erosion and tearing from contact with lugs on the track of the snowmobile.

The plurality of crossbars 18, each having the rung 60 and the grip 70, are positioned on upper surfaces 33 and 35 of the side rails 32 and 34 and are pivotally connected to each side rails 32 and 34 with Mechanical Fasteners 90 that extend through a through bore 80 having a countersunk portion 82 in the top wall 74 of the grip 70 and apertures 68 in a rung 60 that are aligned with apertures 64 and 66 in the upper surfaces 33 and lower surfaces 31 of the side rails 32 and 34. A nut 100 is positioned within a channel 92 in the lower surface 31 of the side rails 32 and 34, where the channel 92 has side walls 96 and 98 that are spaced a distance D that is configured to accept the nut 100 while preventing the nut 100 from rotating as the bolt 90 threadably engages the nut 100. The cross bar 18 is pivotally secured to each of the side rails 32 and 34 by turning the bolt 90 without the need for a wrench for the nut 92. The countersunk portion 82 in the grip 70 accepts a head 91 of the bolt 90, such the head 91 is even with or below a top surface 71 of the grip 70, so that the lugs of the track do not engage the head 91 of the bolt 90.

Washers 102 are positioned about the bolt 90 and between the cross bars 18 and the side rails 32 and 34 to reduce friction between the cross bars 18 and the side rails 32 and 34. While washers are illustrated and disclosed, the present disclosure does not require washers. Further, the washers can be replaced with any similar functioning part, including but not limited to shims, bushings and plates.

The grips 70 are secured to the rungs 60 between side rails 32 and 34 with a plurality of mechanical fasteners 110 and Receiving fasteners positioned through aligned apertures in the rungs 60 and the grips 70. The aperture in the grips 70 includes a countersunk portion that accepts the head of the bolt 110, such that the lugs of the track of the snow machine do not engage the heads.

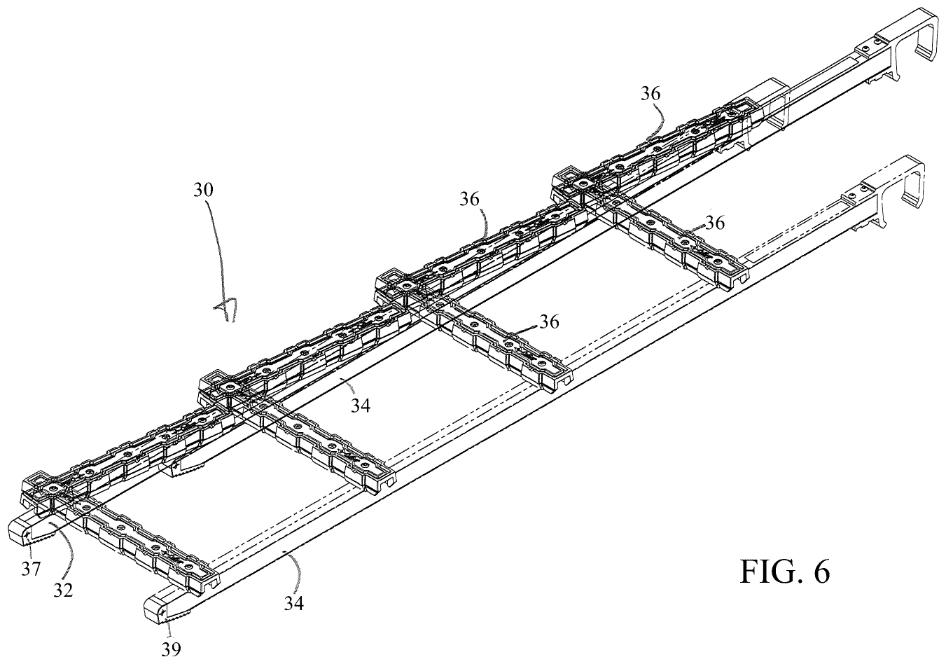

Attaching the cross bars 36 to the side rails 32 and 34 at spaced apart pivot points at the mechanical fastener 90 allows the side rail 34 to pivot upwardly toward the side rail 32 such that the mounting hook 42 is above the mounting hook 40, as illustrated in FIG. 6. Alternatively, the side rail 34 can be pivoted downwardly such that the mounting hook 42 is below the hook 40. In cither configuration, the traction ladder 30 can be stored and transported in a compact configuration.

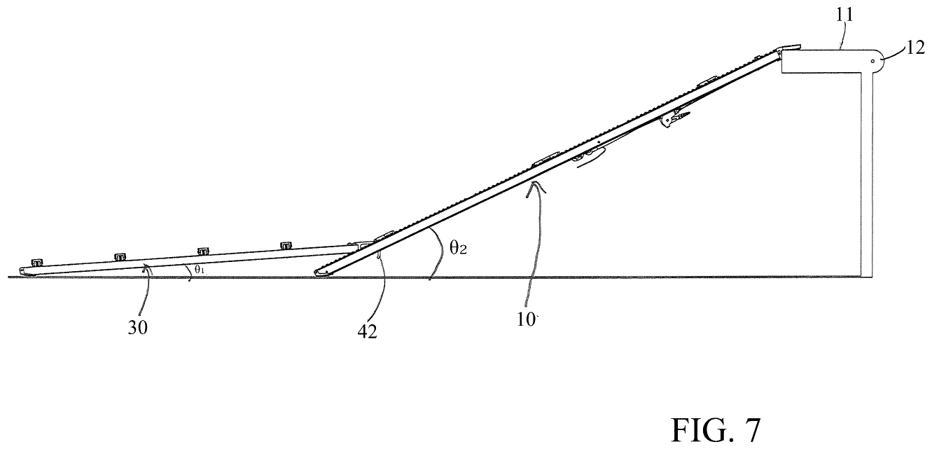

Referring to FIGS. 1 and 7, to use the traction ladder 30, the side rails 32 and 34 are pivoted about the mechanical fastener 90 away from each other such that the cross bars 36 are substantially orthogonal to the side rails 32 and 34 and the mounting hooks 40 and 42 are substantially even. With the ramp 10 secured to the bed or floor 22, the ramp is at angle θ₁. The mounting hooks 40 and 42 are positioned proximate a cross bar 18 of the ramp 10 and are lowered onto the cross bar 18 through the constricted entrances 38 such that the cross bar 18 is positioned within the cavities 36. The prongs 50 and 52 with the inwardly facing fingers 54 and 56 retain the mounting hooks 40 and 42 to the cross bar 18 such that the proximal ends 41 and 32 with grips 37 and 39 engage ground level where the traction ladder 30 is at an angle θ₂, where θ₂ is at a shallower angle than θ₁.

With the traction ladder 30 secured to the cross bar 18 of the ramp 10, the snow machine is driven toward the ramp 10 and the skis engage the left and right outer portions 12 and 14 at the angle θ₁. The track of the snow machine track engages the cross bars 36 of the traction ladder 30 at the angle θ₂, which being at a shallower angle than θ₁ provides a gradual elevation of the track from ground level to the cross bars 18 of the ramp 10 as the skies move upward on the left and right outer portions 12 and 14 to the platform 12 of a transportation vehicle or accessory. Having the track raise from ground level at an angle θ₂ on the traction ladder 30 and the engage the cross bars 18 at the angle θ₁ on the ramp 10 as the skis climb the left and right outer portions 12 and 14, aids in loading the snow machine on the platform 12 of a transportation vehicle or accessory and prevents the track from spinning out.

Once the snow machine is loaded onto the platform 12 of a transportation vehicle or accessory, the mounting hooks 40 and 42 are removed from the cross bar 18 and the side rails 30 and 32 are pivoted toward each other about the Mechanical Fastener 90 such that the side rails 30 and 32 are adjacent each other in a compact configuration. With the traction ladder 30 in the compact position, the traction ladder can be stored for transport with the snow machine.

Although the present invention has been described with reference to preferred embodiments, workers skilled in the art will recognize that changes may be made in form and detail without departing from the spirit and scope of the invention.

1. A traction ladder configured to engage a ramp engaging a bed of a truck or trailer, the traction ladder comprising:
a first side rail having a first proximal end configured to engage the ground and a first distal end configured to engage a crossbar of the ramp;
a second side rail having a second proximal end configured to engage the ground and a second distal end configured to engage a crossbar of the ramp; and
a plurality of crossbars spaced from each other, each cross bar being pivotally attached to the first side rail at a first pivot and pivotally attached to the second side rail at a second pivot;
wherein the first and second siderails are moved to a first position by pivoting the first and second sider rails about the first and second pivots such that the plurality of crossbars are substantially orthogonal to the first and second side rails and the first and second side rails are moved to a second position by pivoting the first and second side rails about the first and second pivots such that the first and second side rails are positioned proximate each other.

2. The traction ladder of claim 1 wherein each of the first and second distal ends of the first and second side rails comprises mounting hooks configured to engage the cross bar of the ramp.

3. The traction ladder of claim 2, where each of the mounting hooks comprises:
an upper portion; and
spaced apart prongs extending from the upper portion, wherein the upper portion and the spaced apart prongs define a cavity configured to accept the crossbar of the ramp, wherein the cavity includes a constricted entrance configured to pass about the crossbar of the ramp and to retain the traction ladder to the ramp.

4. The traction ladder of claim 1 wherein the first and second pivots comprise Mechanical Fasteners extending through the traction ladder crossbars and the first and second side rails respectively, wherein Receiving Fasteners engage the Mechanical Fasteners to pivotally retain the traction ladder crossbars to the first and second side rails.

5. The traction ladder of claim 4, wherein each of the first and second side rails comprise a channel on a bottom surface thereof, wherein the channel is of a width to accept the nut while preventing the nut from rotating as the bolt threadably engages the nut.

6. The traction ladder of claim 1 wherein each crossbar comprises:
a rung having a length between a first end and a second end; and
a grip positioned over the rung and secured thereto, the grip being of a material configured to engage lugs of a track on a vehicle without excessive erosion.

7. The traction ladder of claim 6, where the grip comprises:
a top portion; and
spaced apart tabs extending from the top portion, wherein the top portion and the spaced apart tabs define a channel configured to accept the rung such that the rung does not directly contact the lugs on the track on a vehicle.

8. The traction ladder of claim 7, wherein the top portion of the grip comprises a plurality of spaced apart countersunk through bores configured to accept a head a bolt of the first and second pivot.

9. The traction ladder of claim 1 and further comprising a member located between the plurality of traction ladder crossbars and the first and second side rails at the first and second pivots, wherein the member reduces friction as the first and second side rails are moved between the first position and the second position.

10. A method for loading a snow machine having spaced apart skis and a track from ground level onto a platform of a transportation vehicle or accessory, the method comprising:
positioning a ramp from ground level to the platform of a transportation vehicle or accessory at an angle θ₁;
providing a traction ladder comprising:
a first side rail having a first proximal end configured to engage the ground and a first distal end configured to engage a crossbar of the ramp;
a second side rail having a second proximal end configured to engage the ground and a second distal end configured to engage a crossbar of the ramp; and
a plurality of crossbars spaced from each other, each cross bar being pivotally attached to the first side rail at a first pivot and pivotally attached to the second side rail at a second pivot;
moving the first and second side rails to a first position by pivoting the first and second side rails about the first and second pivots such that the plurality of crossbars of the traction ladder are substantially orthogonal to the first and second side rails;
attaching the first and second distal ends to the crossbar of the ramp such that the traction ladder is at an angle θ₂, where θ₂ is less than θ₁;
moving the snow machine such that the skis of the snow machine engage the ramp at the angle θ₁ while the track engages the traction ladder at angle θ₂ such that the track more readily transitions to the ramp at angle θ₁ as the skis move up the ramp.

11. The method of claim 10 and further comprising:
detaching the first and second distal ends of the traction ladder from the crossbar of the ramp after the snow machine is on the platform of the transportation vehicle or accessory; and
moving the first and second side rails to a second position by pivoting the first and second side rails about the first and second pivots such that the first and second side rails are positioned proximate each other for storage and transportation.

12. The method of claim 10 and further comprising providing mounting hooks on the distal ends of the first and second rails.

13. The method of claim 12 and wherein attaching the first and second distal ends to the crossbar of the ramp such that the traction ladder is at an angle θ₂ comprises positioning the mounting hoods about the cross bar of the ramp.

14. The method of claim 10 and further comprising removing the ramp from the bed after the snow machine is positioned on the bed of the truck or trailer.

15. The method of claim 14 and further comprising the first and second side rails proximate each other to position the traction ladder in a compact configuration for storage and transportation.
